(19) United States
(12) Patent Application Publication
(10) Pub. No.: US 2024/0269762 A1
(43) Pub. Date: Aug. 15, 2024

(54) WELDING DEVICE FOR CYLINDRICAL BATTERY CELL

(71) Applicant: LG ENERGY SOLUTION, LTD., Seoul (KR)

(72) Inventors: Jae-Young WOO, Daejeon (KR); Duk-Hyun RYU, Daejeon (KR)

(73) Assignee: LG ENERGY SOLUTION, LTD., Seoul (KR)

(21) Appl. No.: 18/564,971

(22) PCT Filed: Jun. 3, 2022
(86) PCT No.: PCT/KR2022/007951

§ 371 Date: Nov. 28, 2023

(30) Foreign Application Priority Data
Jun. 10, 2021 (KR) 10-2021-0075731
May 25, 2022 (KR) 10-2022-0063978

(51) Int. Cl. B23K 11/00; B23K 11/31; B23K 101/36

(52) U.S. Cl. CPC B23K 11/002; B23K 11/318; B23K 2101/36

(57) ABSTRACT

A welding device includes a welding rod configured to be inserted into a winding center hole provided at a winding center of an electrode assembly inserted into a battery can to weld an electrode tab of the electrode assembly or an electric connection component coupled with the electrode tab to a bottom surface of the battery can. The welding rod includes a center rod located at a center of the welding rod; and an exterior cover configured to cover an outer circumference of the center rod. The exterior cover is configured to be movable in a first direction away from the center rod and in a second direction toward the center rod.

### TECHNICAL FIELD

The present application claims priority to Korean Patent Application No. 10-2021-0075731 filed on Jun. 10, 2021 and Korean Patent Application No. 10-2022-0063978 filed on May 25, 2022 in the Republic of Korea, the disclosures of which are incorporated herein by reference.

The present disclosure relates to a welding device for a cylindrical battery cell.

### BACKGROUND ART

Secondary batteries that have ease of application according to product groups and have electrical characteristics such as high energy density are universally applied not only to portable devices, but also to electric vehicles (EVs) or hybrid electric vehicles (HEVs) driven by an electric drive source. These secondary batteries are attracting attention as a new energy source for improving eco-friendliness and energy efficiency because they not only have the primary advantage of dramatically reducing the use of fossil fuels, but also do not generate any by-products from the use of energy.

Types of secondary batteries currently widely used include lithium-ion batteries, lithium polymer batteries, nickel cadmium batteries, nickel hydrogen batteries, nickel zinc batteries, and the like. Such a unit secondary battery cell, that is, a unit battery cell, has an operating voltage of about 2.5 V to 4.5 V. Therefore, when a higher output voltage is required, a battery pack may be configured by connecting a plurality of battery cells in series. In addition, a plurality of battery cells may be connected in parallel to form a battery pack according to the charge/discharge capacity required for the battery pack. Accordingly, the number of battery cells included in the battery pack may be variously set according to a required output voltage and/or charge/discharge capacity.

On the other hand, the cylindrical battery cell is manufactured in such a way that a jelly-roll type electrode assembly is accommodated in a battery can together with an electrolyte. At this time, a negative electrode tab protruding downward from the jelly-roll type electrode assembly is coupled to an electric connection component such as a current collecting plate or a lead tab by welding, and then is accommodated in the battery can. Then, the bottom surface of the battery can and the electric connection component are joined by welding.

On the other hand, as such a welding method, a resistance welding method is mainly employed, and during this welding process, damage to the electrode assembly or the separator may occur. For example, damage to the electrode assembly or the separator may occur due to friction between the welding rod and the electrode assembly while the welding rod is inserted into a winding center hole provided at the winding center of the jelly-roll type electrode assembly. In addition, since the temperature of the welding rod is very elevated after welding, the risk of damage to the electrode assembly or the separator is higher when the high-temperature welding rod is taken out.

Therefore, it is required to find a way to minimize damage to the jelly-roll type electrode assembly or the separator when welding the electric connection component and the bottom surface of the battery can.

### DISCLOSURE

### Technical Problem

The present disclosure is designed to solve the problems of the related art, and therefore the present disclosure is directed to minimizing damage to an electrode assembly and/or a separator, when performing welding for bonding a bottom surface of a battery can and an electric connection component connected to an electrode tab of the electrode assembly such as a current collecting plate or a lead tab.

In particular, the present disclosure is directed to providing a welding device capable of expanding a winding center hole of an electrode assembly, thereby preventing a direct contact between a high-temperature welding portion and an electrode assembly, thereby preventing friction between the high-temperature welding part portion and the electrode assembly, resulting in minimizing the occurrence of defects in the electrode assembly.

However, the technical object to be solved by the present disclosure is not limited to the above, and other objects not mentioned herein will be clearly understood by those skilled in the art from the following disclosure.

### Technical Solution

In one aspect of the present disclosure, there is provided a welding device, which includes a welding rod configured to be inserted into a winding center hole provided at a winding center of an electrode assembly inserted into a battery can to weld an electrode tab of the electrode assembly or an electric connection component coupled with the electrode tab to a bottom surface of the battery can, wherein the welding rod includes: a center rod located at a center of the welding rod in a diameter direction; and an exterior cover configured to cover an outer circumference of the center rod and installed to be movable in a first direction away from the center rod and in a second direction closer to the center rod. As the exterior cover moves in the first direction, the exterior cover may be configured to press an inner wall of the winding center hole to increase a diameter of the winding center hole.

The center rod may have a shape in which a diameter thereof is longer than a length thereof.

The first direction and the second direction may be directions parallel to a radial direction of the center rod.

The exterior cover may include a plurality of unit covers configured to cover a part of the outer circumference of the center rod and arranged along a perimeter of the outer circumference.

The plurality of unit covers may be configured to increase an outer diameter of the welding rod by moving along the first direction.

The plurality of unit covers may be configured such that a distance between adjacent unit covers increases according to the movement in the first direction and the distance between adjacent unit covers decreases according to the movement in the second direction.

The plurality of unit covers may be configured such that adjacent unit covers partially overlap each other according to an operating state.

A length of the welding rod in a longitudinal direction may be greater than or equal to a length of the electrode assembly in a height direction.

A minimum outer diameter of the welding rod according to an operating state of the exterior cover may be equal to or smaller than a diameter of the winding center hole of the electrode assembly.

Thermal conductivity of the exterior cover may be lower than thermal conductivity of the center rod.

One of both longitudinal ends of the center rod, which is inserted toward the bottom surface of the battery can, may be exposed to the outside of the exterior cover.

At least one of the center rod and the exterior cover may be configured to be movable along an extension direction of the center rod such that one of both longitudinal ends of the center rod, which is inserted toward the bottom surface of the battery can, is exposed to the outside of the exterior cover or covered by the exterior cover.

The welding device may further comprise a support body configured to support the welding rod.

The support body may have an insert hole into which the welding rod is inserted, and the plurality of unit covers may be configured to move along the first direction and the second direction within a space formed between an inner wall of the insert hole and the center rod.

The support body may include at least one control unit configured to control movement of the welding rod.

Each of the plurality of unit covers may be configured to be mechanically connected to the control unit to move in the first direction and the second direction according to motion of the control unit.

Each of the plurality of unit covers may be configured to move in the first direction and the second direction by an actuator electronically controlled by the control unit.

The welding device may further comprise a support body configured to support the welding rod.

The support body may have an insert hole into which the welding rod is inserted, and at least one of the center rod and the exterior cover may be configured to be movable along the extension direction of the center rod inside the insert hole.

The support body may include at least one control unit configured to control movement of at least one of the center rod and the exterior cover.

At least one of the center rod and the exterior cover may be configured to be mechanically connected to the control unit to move in a direction parallel to an extension direction of the center rod according to motion of the control unit.

At least one of the center rod and the exterior cover may be configured to move in a direction parallel to an extension direction of the center rod by an actuator electronically controlled by the control unit.

### Advantageous Effects

According to the present disclosure, in performing welding for bonding between an electric connection component such as a current collecting plate or a lead tab and the bottom surface of a battery can, damage to a jelly-roll type electrode assembly or a separator may be minimized.

In particular, according to the welding device of the present disclosure, it is possible to expand the winding center hole of the jelly-roll type electrode assembly. Therefore, direct contact between the high-temperature welding portion and the electrode assembly may be prevented. In addition, by preventing friction between the high-temperature welding portion and the electrode assembly, it is possible to minimize the occurrence of defects in the electrode assembly.

In addition, the present disclosure may have various other effects, which will be described in each embodiment, or a corresponding description will be omitted for effects that can be easily inferred by a person skilled in the art.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram for explaining a welding device according to an embodiment of the present disclosure.

FIG. 2 is a diagram for explaining a welding rod of the welding device of FIG. 1.

FIG. 3 is a diagram for explaining an exterior cover according to another embodiment of the present disclosure.

FIG. 4 is a diagram for explaining an exterior cover of the welding rod of FIG. 2.

FIG. 5 is a diagram for explaining an exterior cover according to another embodiment of the present disclosure.

FIG. 6 is a diagram of FIG. 2, viewed in an A direction.

FIG. 7 is a diagram for explaining a support body of the welding device of FIG. 1.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

In addition, in order to help understanding of the present disclosure, the accompanying drawings are not drawn to scale, but dimensions of some components may be exaggerated.

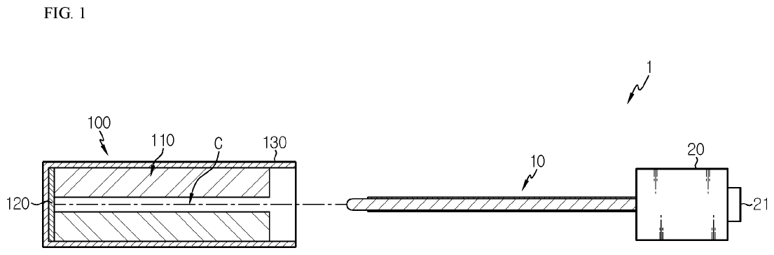

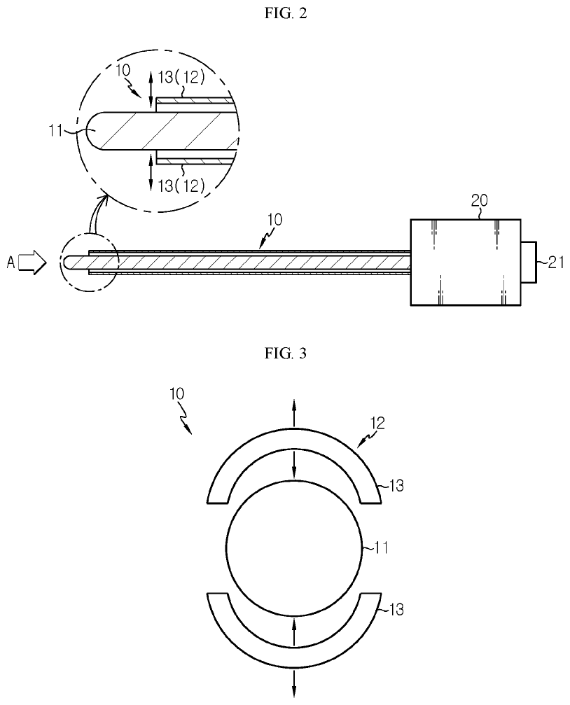

FIG. 1 is a diagram for explaining a welding device according to an embodiment of the present disclosure, and FIG. 2 is a diagram for explaining a welding rod of the welding device of FIG. 1.

Referring to FIGS. 1 and 2, a welding device 1 according to an embodiment of the present disclosure includes a welding rod 10. The welding device 1 may further include a support body 20.

The welding device 1 is configured to be inserted into a winding center hole C provided at a winding center of an electrode assembly 110 inserted into a battery can 130 of a cylindrical battery cell 100 to weld an electrode tab (not shown) provided in the electrode assembly 110 or an electric connection component 120 coupled with the electrode tab to a bottom surface of the battery can 130.

The electrode assembly 110 may be, for example, a jelly-roll type electrode assembly. The electric connection component 120 means, for example, a component for electrically connecting the electrode assembly 110 and the battery can 130, like an electrode current collecting plate or a lead tab coupled to an electrode tab (not shown) protruding downward from the electrode assembly 110. In the drawings of the present disclosure, the electric connection component 120 is illustrated as an electrode current collecting plate as an example. Meanwhile, the welding method may be, for example, a resistance welding method.

Referring to FIGS. 1 and 2, the welding rod 10 includes a center rod 11 positioned at the center of the welding rod 10 in the diameter direction and an exterior cover 12 that covers the outer circumference of the center rod 11.

A length of the welding rod 10 in the longitudinal direction may be greater than or equal to a length of the electrode assembly 110 in the height direction. For example, referring to FIG. 1, the length of the welding rod 10 in the longitudinal direction is greater than the length of the electrode assembly 110 in the height direction, which is accommodated in the battery can 130. Accordingly, an end of the welding rod 10 may contact the electric connection component 120 coupled to the electrode tab (not shown) of the electrode assembly 110. Accordingly, the electric connection component 120 and the bottom surface of the battery can 130 may be easily welded.

Referring to FIGS. 1 and 2, the center rod 11 is located approximately at the center of the welding rod 10 in the diameter direction. The center rod 11 may have a shape in which its diameter is longer than its length. That is, the center rod 11 may have an approximately cylindrical shape that is thin and long. For example, referring to FIG. 1, the center rod 11 may have an approximately needle shape with a relatively small diameter compared to its length.

As a direction parallel to the radial direction of the center rod 11, a first direction and a second direction may be defined. For example, referring to FIG. 2, the center rod 11 may be assumed to be an approximately cylinder whose central axis is parallel to the length direction of the center rod 11. At this time, in the radial directions of the cylinder, a +r direction may be defined as the first direction, and a −r direction may be defined as the second direction. That is, the first direction may be a direction away from the central axis of the center rod 11, and the second direction may be a direction closer to the central axis of the center rod 11.

Referring to FIG. 2, one of both longitudinal ends of the center rod 11, which is inserted toward the inner bottom surface of the battery can 130, may be exposed to the outside of the exterior cover 12. If the end of the center rod 11 is not exposed to the outside of the exterior cover 12, it may not be easy for the center rod 11 to contact the electric connection component 120. Therefore, the end of the center rod 11 may be exposed to the outside of the exterior cover 12 for easy welding. However, the end of the center rod 11 is not limited to always being exposed to the outside of the exterior cover 12. That is, at least one of the center rod 11 and the exterior cover 12 may be configured to be movable along the extension direction of the center rod 11 such that one of both longitudinal ends of the center rod 11, which is inserted toward the inner bottom surface of the battery can 130, is exposed to the outside of the exterior cover 12 or covered by the exterior cover 12.

For example, before welding, the end of the welding rod 10 may be retracted to the inside of the exterior cover 12, and only when welding is performed, the end of the welding rod 10 may be exposed to the outside of the exterior cover 12. Also, on the contrary, it is also possible that the position of the welding rod 10 is fixed and the exterior cover 12 moves along the length direction of the welding rod 10 so that the end of the welding rod 10 is exposed to the outside of the exterior cover 12 or covered by the exterior cover 12. In addition, it is also possible that the end of the welding rod 10 is exposed to the outside of the exterior cover 12 or completely covered by the exterior cover 12 by moving both the welding rod 10 and the exterior cover 12.

Referring to FIGS. 1 and 2, the exterior cover 12 covers the outer circumference of the center rod 11 and may be installed to be movable in the first direction away from the center rod 11 and in the second direction closer to the center rod 11. As moving in the first direction, the exterior cover 12 may be configured to press an inner wall of the winding center hole C to increase the diameter of the winding center hole C. Accordingly, a predetermined gap may be secured between the electrode assembly 110 and the center rod 11. In consideration of this function, the minimum outer diameter of the welding rod 10 according to the operating state of the exterior cover 12 may be formed to be equal to or smaller than the diameter of the winding center hole C of the electrode assembly 110.

The thermal conductivity of the exterior cover 12 may be equal to or lower than the thermal conductivity of the center rod 11. For example, the material of the exterior cover 12 may be the same as the material of the center rod 11. Since the center rod 11 performs resistance welding, it is generally made of metal. At this time, the material of the exterior cover 12 may also be metal. In this case, the rigidity of exterior cover 12 may be secured to a certain level. Therefore, the exterior cover 12 may easily increase the diameter of the winding center hole C.

On the other hand, the thermal conductivity of the exterior cover 12 may be lower than the thermal conductivity of the center rod 11. According to the configuration of the present disclosure, it is possible to minimize the transfer of heat from the center rod 11 heated to a high temperature for welding to the electrode assembly 110, thereby preventing damage to the electrode assembly 110. In particular, a separator may be disposed on the inner wall of the winding center hole C of the electrode assembly 110, and in this case, damage to the separator may be prevented by lowering the thermal conductivity of the exterior cover 12. For example, the material of the exterior cover 12 may be a high-strength plastic material with excellent rigidity and low thermal conductivity. In this case, the high-strength plastic may contain, for example, glass fibers in order to withstand a significant increase in the temperature of the center rod 11. As a material of the exterior cover 12, in addition, for example, a ceramic material may be applied. When a material having lower thermal conductivity than the center rod 11 is applied as the material of the exterior cover 12, the heat of the high temperature center rod 11 is not well conducted to the exterior cover 12. Accordingly, the exterior cover 12 may serve as a thermal shield between the center rod 11 and the electrode assembly 110, thereby preventing thermal damage to the electrode assembly 110.

However, the material of the exterior cover 12 is not limited thereto, and various materials having high rigidity even in a thin thickness may be applied to the exterior cover 12.

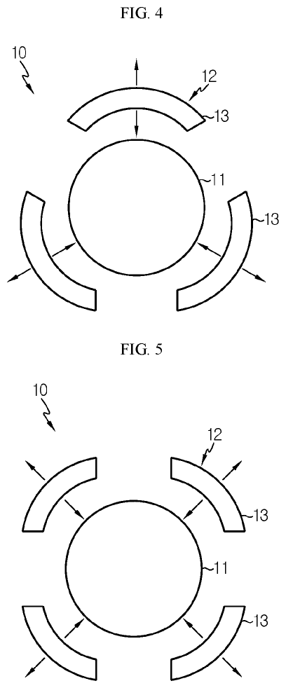

FIG. 4 is a diagram for explaining an exterior cover of the welding rod of FIG. 2, and FIGS. 3 and 5 are diagrams for explaining exterior covers according to other embodiment of the present disclosure.

Referring to FIGS. 3 to 5, the exterior cover 12 may include a plurality of unit covers 13 that cover a part of the outer circumference of the center rod 11 and are arranged along a perimeter of the outer circumference. In this case, the plurality of unit covers 13 may be configured to increase the outer diameter of the welding rod 10 by moving along the first direction.

For example, the exterior cover 12 includes two unit covers 13 in FIG. 3, the exterior cover 12 includes three unit covers 13 in FIG. 4, and the exterior cover 12 includes four unit covers 13 in FIG. 5. As the exterior cover 12 includes a greater number of unit covers 13, the shape of the expanding winding center hole C may be closer to a circular shape. For example, in FIG. 3, since exterior cover 12 includes two unit cover 13, the unit cover 13 has a structure that opens to both sides. Therefore, at this time, the shape of the winding center hole C becomes an approximately elliptical shape. On the other hand, in FIG. 5, since the exterior cover 12 includes four unit covers 13, the unit covers 13 have a structure that opens in 4 directions at intervals of 90 degrees. Therefore, the shape of the winding center hole C at this time becomes approximately circular.

Referring to FIGS. 3 to 5, when the exterior cover 12 extends along the first direction, the distance between the plurality of unit covers 13 may be changed. For example, the plurality of unit covers 13 may be configured such that a distance between adjacent unit covers 13 increases according to the movement in the first direction, and a distance between adjacent unit covers 13 decreases according to the movement in the second direction. The plurality of unit covers 13 may be configured to surround the center rod 11 without being spaced apart from each other so that the center rod 11 is not exposed to the outside of the exterior cover 12, before the exterior cover 12 is expanded. However, when the unit covers 13 move in the first direction for the expansion of the exterior cover 12, the distance between the unit covers 13 may increase. Meanwhile, although not specifically illustrated in the drawings, the plurality of unit covers 13 may be configured such that adjacent unit covers 13 partially overlap each other according to an operating state. In this case, the overlapping area of the unit covers 13 adjacent to each other may be formed to be widest in a state before the exterior cover 12 is expanded. Conversely, in a state where the exterior cover 12 is expanded to the maximum, the overlapping area of adjacent unit covers 13 may be minimized, or the adjacent unit covers 13 may be spaced apart from each other not to generate an overlapping area.

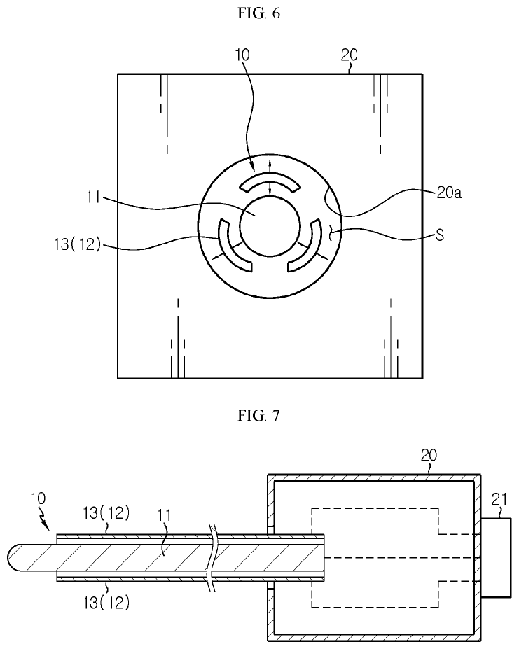

FIG. 6 is a diagram of FIG. 2, viewed in an A direction, and FIG. 7 is a diagram for explaining a support body 20 of the welding device 1 of FIG. 1.

Referring to FIGS. 6 and 7, the support body 20 may be configured to support the welding rod 10. For example, the support body 20 may be coupled to the welding rod 10 at one longitudinal side of the welding rod 10. The support body 20 may include an insert hole 20a.

The plurality of unit covers 13 may move along the first direction or the second direction within a space formed between the inner wall of the insert hole 20a and the center rod 11. For example, referring to FIGS. 6 and 7, the support body 20 may have an insert hole 20a in which the welding rod 10 and the exterior cover 12 may be accommodated, and at this time, a space S may be formed between the center rod 11 and the inner wall of the insert hole 20a.

Referring to FIG. 7, the support body 20 may include at least one control unit 21. The control unit 21 may be configured to control movement of the welding rod 10. For example, the control unit 21 may be a mechanical control unit or an electronic control unit.

Specifically, for example, each of the plurality of unit covers 13 may be configured to be mechanically connected to the control unit 21 to move in the first direction and the second direction according to motion of the control unit 21. More specifically, for example, an arm to which a plurality of hinges are coupled may be connected to each of the plurality of unit covers 13, and the control unit 21 may be a button or dial connected to the plurality of arms and configured to control movement of the plurality of arms. However, in the present disclosure, the mechanical connection structure for controlling the movement of the plurality of unit covers 13 through the control unit 21 is not limited thereto, and any mechanical connection structure capable of increasing and decreasing the outer diameter of the welding rod 10 by controlling the motion of the plurality of unit covers 13 may be applicable to the present disclosure. Alternatively, each of the plurality of unit covers 13 may have a structure that moves in the first direction or the second direction by an actuator (not shown) electronically controlled by the control unit 21. For example, a motor may be provided inside the support body 20, and the motor and the control unit 21 may be electrically connected. At this time, by operating the motor through the control unit 21, the unit cover 13 connected to the motor may move in the first direction or the second direction. Therefore, the diameter of the welding rod 10 may be increased or decreased.

Meanwhile, the control unit 21 may move the center rod 11 and/or the exterior cover 12 along a direction parallel to the central axis of the welding rod 10. That is, the support body 20 may include at least one control unit configured to control the operation of at least one of the center rod 11 and the exterior cover 12. At least one of the center rod 11 and the exterior cover 12 may be mechanically connected to the control unit 21 and configured to operate in a direction parallel to the extension direction of the center rod 11 according to the motion of the control unit 21. Alternatively, at least one of the center rod 11 and the exterior cover 12 may be configured to operate in a direction parallel to the extension direction of the center rod 11 by an actuator (not shown) electronically controlled by the control unit 21.

For example, when the welding rod 10 is inserted into the winding center hole C of the electrode assembly 110 or withdrawn from the winding center hole C, the control unit 21 may be manipulated to move the center rod 11 toward the support body 20 or to move the exterior cover 12 away from the support body 20 so that the longitudinal end of the support body 20 is not exposed to the outside of the exterior cover 12, thereby preventing contact between the center rod 11 and the electrode assembly 110. Of course, it is also possible to move the center rod 11 toward the support body 20 and to move the exterior cover 12 away from the support body 20 by manipulating the control unit 21.

In addition, when performing welding, the control unit 21 may be manipulated to move the center rod 11 away from the support body 20 or to move the exterior cover 12 toward the support body 20 so that the longitudinal end of the support body 20 is exposed to the outside of the exterior cover 12, thereby allowing the center rod 11 and the electric connection component 120 to easily contact each other. Of course, it is also possible to move the center rod 11 away from the support body 20 and to move the exterior cover 12 toward the support body 20 by manipulating the control unit 21.

In the present disclosure, the control unit 21 for controlling the movement for exposing and hiding the center rod 11 and the control unit 21 for controlling the change of the outer diameter of the welding rod 10 may be the same control unit, or may be different control units provided separately.

On the other hand, although terms indicating directions such as up and down are used in this specification, these terms are only for convenience of explanation, and it is obvious to those skilled in the art of the present disclosure that they may vary depending on the location of a target object or the location of an observer.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### EXPLANATION OF SIGNS

1 welding device
10 welding rod
11 center rod
12 exterior cover
13 unit cover
20 support body
20a insert hole
21 control unit
100 cylindrical battery cell
110 electrode assembly
120 electric connection component
130 battery can
C winding center hole

1. A welding device comprising:
a welding rod configured to be inserted into a winding center hole provided at a winding center of an electrode assembly inserted into a battery can to weld an electrode tab of the electrode assembly or an electric connection component coupled with the electrode tab to a bottom surface of the battery can, the welding rod including:
a center rod located at a center of the welding rod; and
an exterior cover configured to cover an outer circumference of the center rod, the exterior cover being configured to be movable in a first direction away from the center rod and in a second direction toward the center rod.

2. The welding device according to claim 1, wherein, as the exterior cover moves in the first direction, the exterior cover is configured to press an inner wall of the winding center hole to increase a diameter of the winding center hole.

3. The welding device according to claim 1, wherein the center rod has a shape in which a length thereof is longer than a diameter thereof.

4. The welding device according to claim 1, wherein the first direction and the second direction are directions parallel to a radial direction of the center rod.

5. The welding device according to claim 1, wherein the exterior cover includes a plurality of covers, each cover being configured to cover a part of the outer circumference of the center rod, each cover being arranged along a perimeter of the outer circumference of the center rod.

6. The welding device according to claim 5, wherein the plurality of covers are configured to increase an outer diameter of the welding rod by moving along the first direction.

7. The welding device according to claim 6, wherein the plurality of covers are configured such that a distance between adjacent covers increases according to the movement in the first direction and the distance between adjacent covers decreases according to the movement in the second direction.

8. The welding device according to claim 6, wherein the plurality of unit covers are configured such that adjacent covers partially overlap each other according to an operating state.

9. The welding device according to claim 1, wherein a length of the welding rod in a longitudinal direction is greater than or equal to a length of the electrode assembly in a height direction.

10. The welding device according to claim 1, wherein a minimum outer diameter of the welding rod according to an operating state of the exterior cover is equal to or smaller than a diameter of the winding center hole of the electrode assembly.

11. The welding device according to claim 1, wherein thermal conductivity of the exterior cover is lower than thermal conductivity of the center rod.

12. The welding device according to claim 1, wherein one end of the center rod configured to be inserted toward the bottom surface of the battery can is exposed beyond the exterior cover.

13. The welding device according to claim 1, wherein at least one of the center rod and the exterior cover is configured to be movable along an extension direction of the center rod such that one end of the center rod configured to be inserted toward the bottom surface of the battery can is exposed beyond the exterior cover or is covered by the exterior cover.

14. The welding device according to claim 5, further comprising a support body configured to support the welding rod.

15. The welding device according to claim 14, wherein the support body has an insert hole into which the welding rod is inserted, and
wherein the plurality of covers are configured to move along the first direction and the second direction within a space formed between an inner wall of the insert hole and the center rod.

16. The welding device according to claim 14, wherein the support body includes at least one controller configured to control movement of the welding rod.

17. The welding device according to claim 16, wherein each of the plurality of covers is configured to be mechanically connected to the controller to move in the first direction and the second direction according to motion of the controller.

18. The welding device according to claim 16, wherein each of the plurality of covers is configured to move in the first direction and the second direction by an actuator electronically controlled by the controller.

19. The welding device according to claim 13, further comprising a support body configured to support the welding rod.

20. The welding device according to claim 19, wherein the support body has an insert hole into which the welding rod is inserted, and
wherein at least one of the center rod and the exterior cover is configured to be movable along the extension direction of the center rod inside the insert hole.

21. The welding device according to claim 19, wherein the support body includes at least one controller configured to control movement of at least one of the center rod and the exterior cover.

22. The welding device according to claim 21, wherein at least one of the center rod and the exterior cover is configured to be mechanically connected to the controller to move in a direction parallel to the extension direction of the center rod according to motion of the controller.

23. The welding device according to claim 21, wherein at least one of the center rod and the exterior cover is configured to move in a direction parallel to the extension direction of the center rod by an actuator electronically controlled by the controller.
